(19) United States
(12) Patent Application Publication
(10) Pub. No.: US 2014/0260602 A1
(43) Pub. Date: Sep. 18, 2014

(54) WATER-LEVEL DETECTING SYSTEM AND WATER-LEVEL DETECTING METHOD

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: PENG ZHANG, Wuhan (CN); YU-LIN LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/062,616

(22) Filed: Oct. 24, 2013

(30) Foreign Application Priority Data
Mar. 18, 2013 (CN) 2013100852435

(51) Int. Cl. G01F 23/68

(52) U.S. Cl. CPC G01F 23/68
USPC 73/313

(57) ABSTRACT

A water-level detecting system includes a water receiving module located in an electronic device, a first sliding rheostat, a varicap, a frequency-to-voltage converter, a comparing module, and an indicator module. The water receiving module includes a water tank, a floating block received in the water tank, and a connecting portion. The floating block is moved by the rising water level in the water tank to slide the first sliding rheostat. A voltage of the varicap is changeable when the first sliding rheostat slides, and a voltage of the frequency-to-voltage converter is changeable according to the voltage of the varicap. The comparing module compares the voltage of the frequency-to-voltage converter with a predetermined voltage, and the indicator module lights up when the voltage of the frequency-to-voltage converter is greater than the predetermined voltage. The disclosure further offers a water-level detecting method.

### BACKGROUND

1. Technical Field

The present disclosure relates to water-level detecting systems, and more particularly to a water-level detecting system and a water-level detecting method for a vending machine.

2. Description of Related Art

Vending machines often comprise a cooling system for absorbing heat generated by the vending machine. In addition, the vending machine further comprises a water receiving device for receiving water condensate generated by the cooling system. However, the water may spill out of the water receiving device and damage the vending machine. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like-reference numerals designate corresponding parts throughout the several views.

FIG. 1 is a block diagram of a water-level detecting system in accordance with an embodiment.

FIG. 2 is a circuit diagram of the water-level detecting system of FIG. 1.

FIG. 3 is a flow chart of the water-level detecting method of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIGS. 1-2 illustrate a water-level detecting system in accordance with an embodiment. The water-level detecting system comprises a signal generating module 10, a detecting module 20, a comparing module 30, an indicator module 40, and a water receiving module 50. The signal generating module 10 and the water receiving module 50 are connected to the detecting module 20. The comparing module 30 is connected to the detecting module 20 and the indicator module 40. In one embodiment, the water-level detecting system is used in a vending mechanism.

The signal generating module 10 comprises a time-base circuit 11, a first capacitor C1, a second capacitor C2, a third capacitor C3, and a diode D1. The time-base circuit 11 comprises a ground pin 1, a low trigger pin 2, an output pin 3, a high trigger pin 6, a discharge pin 7, and a power supply pin 8. The ground pin 1 is connected to a power supply Vcc via the first capacitor C1. The low trigger pin 2 is ground via the second capacitor C2. The output pin 3 is connected to the third capacitor C3, and the third capacitor C3 is connected to the detecting module 20 through a resistor R3. The high trigger pin 6 and the low trigger pin 2 are connected to a node 12. The discharge pin 7 is connected to the power supply Vcc via a resistor R1 and is connected to the node 12 via a resistor R2. An anode of the diode D1 is connected to the discharge pin 7, and a cathode of the diode D1 is connected to the node 12. The power supply pin 8 is connected to the power supply Vcc. In one embodiment, a capacitance of the first capacitor C1 is about 0.1 microfarad (μF), a capacitance of the second capacitor C2 is about 10 μF, a resistance of the resistor R1 is about 6.8 KΩ and is substantially equal to a resistance of the resistor R2, and a resistance of the resistor R3 is about 3.3 KΩ.

The detecting module 20 comprises a frequency-to-voltage converter 21, a varicap 22, a first sliding rheostat 23, a second sliding rheostat 24, a third sliding rheostat 25, and a displaying meter 26. A pin TACH+ of the frequency-to-voltage converter 21 is connected to the resistor R3. A pin CAP1 of the frequency-to-voltage converter 21 is connected to a node 270 via a capacitor C4, and the node 270 is connected to a sliding terminal of the first sliding rheostat 23 via a resistor R4. Two connecting terminals of the first sliding rheostat 23 are connected to the power supply Vcc and grounded, respectively. A pin CPO of the frequency-to-voltage converter 21 is grounded via a resistor R5. A pin IN+ of the frequency-to-voltage converter 21 is grounded via a fifth capacitor C5 and is further connected to the pin CPO of the frequency-to-voltage converter 21. A pin E of the frequency-to-voltage converter 21 is grounded via a resistor R11 and is further connected to a node 271. A pin VCC and a pin C of the frequency-to-voltage converter 21 are connected to the power supply Vcc. A pin IN− of the frequency-to-voltage converter 21 is connected to the node 271. A pin TACH− and a pin GND of the frequency-to-voltage converter 21 are grounded.

A sliding terminal of the second sliding rheostat 24 and a first connecting terminal of the second sliding rheostat 24 are connected to the node 271. A second connecting terminal of the second sliding rheostat 24 is connected to a resistor R6, and the resistor R6 is grounded via the displaying meter 26. A first connecting terminal of the third sliding rheostat 25 is connected to the node 271, and a second connecting terminal of the third sliding rheostat 25 is grounded. A sliding terminal of the third sliding rheostat 25 is connected to the comparing module 30. In one embodiment, a resistance of the resistor R4 is about 470 KΩ, a resistance of the resistor R5 is about 100 MΩ, a resistance of the resistor R6 is about 4.7 KΩ, a capacitance of the fourth capacitor C4 is about 1 μF, and a capacitance of the second capacitor C5 is about 1 μF.

The comparing module 30 comprises a fourth sliding rheostat 31 and an operational amplifier 32. A first connecting terminal of the fourth sliding rheostat 31 is connected to the power supply Vcc, and a second connecting terminal of the fourth sliding rheostat 31 is grounded. A sliding terminal of the fourth sliding rheostat 31 is connected to a negative terminal of the operational amplifier 32. A positive terminal of the operational amplifier 32 is connected to the sliding terminal of the fourth sliding rheostat 31 via a resistor R8. The operational amplifier 32 is also connected to a node 33, and the node 33 is connected to the power supply Vcc via a resistor R9. In one embodiment, a resistance of the resistor R7 is 4.7KΩ, a resistance of the resistor R8 is 4.7 KΩ, and a resistance of the resistor R9 is 1KΩ.

The indicator module 40 comprises an indicator light 41. The node 33 is connected to a resistor R10, and the resistor R10 is grounded via the indicator light 41. In one embodiment, a resistance of the resistor R10 is 470Ω.

The water receiving module 50 comprises a water tank 51, a floating block 52 floating on water of the water tank 51, and a connecting portion 53 connected to the floating block 52. The connecting portion 53 is connected to the sliding terminal of the first sliding rheostat 23.

In use, a water level of the water of the water tank 51 rises up or down and consequently moves the floating block 52 up or down, so that the connecting portion 53 moves the sliding terminal of the first sliding rheostat 23 to change a voltage of the varicap 22. Simultaneously, a frequency value fe is inputted to the detecting module 20 by the time-base circuit 11. A voltage Ue is outputted by the frequency-to-voltage converter 21 and the voltage Ue is obtained by the formula Ue=f*R*U*Cx, where f is the frequency value fe, R is the resistance of the resistor R3, U is the operating voltage of the water-level detecting system, and Cx is the capacitance of the pin CAP1 of the frequency-to-voltage converter 21. Cx is the total capacitance of the capacitor C4 and the varicap 22. Thus, Ue is determined by the capacitance of the varicap 22, and the capacitance can be obtained by the varicap 22 according to the water level of the water in the water tank 51. In one embodiment, the water level of the water in the water tank 51 is displayed by the displaying meter 26. The operational amplifier 32 compares the Ue with a predetermined voltage Up. When the water level of the water in the water tank 51 is greater than a predetermined water level and the Ue is greater than the predetermined voltage Up, the indicator light 41 lights up. When the water level of the water in the water tank 51 is normal and the Ue is less than the predetermined voltage Up, the indicator light 41 does not light up.

FIG. 3 illustrates a delivery detecting method in accordance with an embodiment. The method comprises:

S1: locating a water receiving module 50 in the vending mechanism.

S2: moving the floating block by rising water in the water tank 51 to slide a sliding terminal of the first sliding rheostat 23.

S3: changing a capacitance of the varicap 22, when the sliding terminal of the first sliding rheostat 23 is slid.

S4: changing a voltage of the frequency-to-voltage converter 21 according to the capacitance of the varicap 22.

S5: comparing the voltage of the frequency-to-voltage converter 21 with a predetermined voltage by the comparing module 30.

S6: lighting an indicator module 40 when the voltage of the frequency-to-voltage converter is greater than the predetermined voltage.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A water-level detecting system comprising:
a water receiving module located in a vending machine; the water receiving module comprising a water tank, a floating block received in the water tank, and a connecting portion connected to the floating block;
a first sliding rheostat connected to the connecting portion;
a varicap connected to the first sliding rheostat;
a frequency-to-voltage converter connected to the varicap;
a comparing module connected to the frequency-to-voltage converter; and
an indicator module connected to the comparing module;
wherein the floating block is moveable by water in the water tank to slide a sliding terminal of the first sliding rheostat, a capacitance of the varicap is changeable when the sliding terminal of the first sliding rheostat is slide, a voltage of the frequency-to-voltage converter is changeable according to the capacitance of the varicap, the comparing module is configured to compare the voltage of the frequency-to-voltage converter with a predetermined voltage, and the indicator module is luminous when the voltage of the frequency-to-voltage converter is greater than the predetermined voltage.

2. The water-level detecting system of claim 1, wherein the comparing module comprises an operational amplifier, a positive terminal of the operational amplifier is connected to the frequency-to-voltage converter and configured for receiving the voltage of the frequency-to-voltage converter, and a negative terminal of the operational amplifier is configured for receiving the predetermined voltage.

3. The water-level detecting system of claim 1, wherein the detecting module comprises a first capacitor, a first node, a first resistor, and a first sliding rheostat; a pin CAP1 of the frequency-to-voltage converter is grounded via the first capacitor, the first node and the varicap, the first node is connected to the sliding terminal of the first sliding rheostat via the first resistor, and the connecting portion is connected to the sliding terminal of the first sliding rheostat.

4. The water-level detecting system of claim 3, wherein water-level detecting system further comprises a second sliding rheostat, a third sliding rheostat, a second resistor, a third resistor, a fourth resistor, and a second node; a pin E and a pin IN− of the frequency-to-voltage converter are connected to the second node, a first connecting terminal of the second sliding rheostat is connected to the second node, a sliding terminal of the second sliding rheostat is connected to the positive terminal of the operational amplifier via the second resistor, and a second connecting terminal of the second sliding rheostat is grounded; a sliding terminal of the third sliding rheostat is connected to the negative terminal of the operational amplifier via the third resistor; and the operational amplifier is connected to the indicator module via the fourth resistor.

5. The water-level detecting system of claim 3, wherein the water-level detecting system further comprises a second capacitor and a fifth resistor; a pin CPO of the frequency-to-voltage converter is grounded via a fifth resistor, and a pin IN+ of the frequency-to-voltage converter is connected to the pin CPO and further grounded via the second capacitor.

6. The water-level detecting system of claim 3, wherein the water-level detecting system further comprises a displaying meter, a fourth sliding rheostat, and a six resistor; the displaying meter is configured for displaying the water level in the water tank; a first connecting terminal and a sliding terminal of the fourth sliding rheostat are connected to the second node, a second connecting terminal of the fourth sliding rheostat is connected to the six resistor; and the six resistor is grounded by the displaying meter.

7. The water-level detecting system of claim 3, wherein the water-level detecting system further comprises a seventh resistor and a power supply, the pin E of the frequency-to-voltage converter is grounded via the seventh resistor, and a pin VCC and a pin C of the frequency-to-voltage converter are connected to the power supply.

8. The water-level detecting system of claim 7, wherein a first connecting terminal of the first sliding rheostat is connected to the power supply, a second connecting terminal of the first sliding rheostat is grounded; a first connecting terminal of the third sliding rheostat is connected to the power supply, a second connecting terminal of the third sliding rheostat is grounded.

9. The water-level detecting system of claim 7, further comprising a signal generating module connected to the frequency-to-voltage converter, and the signal generating module is configure to transmit a frequency signal to the frequency-to-voltage converter.

10. The water-level detecting system of claim 9, wherein the signal generating module comprises a base-time circuit, a third node, a third capacitor, a fourth capacitor, a fifth capacitor, a ninth resistor, a tenth resistor, and a eleventh resistor; the time-base circuit comprises an output pin, a ground pin, a low trigger pin, a high trigger pin, a power supply pin, and a discharge pin; the output pin is connected to the third capacitor, the third capacitor is connected to a pin TACH+ of the frequency-to-voltage converter via the ninth resistor; the ground pin is connected to the power supply via the fourth capacitor; the low trigger pin is grounded via the fifth capacitor; the third node is connected to the lower trigger pin and the high trigger pin; the power supply pin is connected to the power supply; the discharge pin is grounded via a ninth resistor; and the eleventh resistor is connected to the discharge pin and the third node.

11. A water-level detecting method comprising:
locating a water receiving module in a vending mechanism; the water receiving module comprising a water tank, a floating block received in the water tank, and a connecting portion connected to the floating block;
moving the floating block by rising water in the water tank to slide a sliding terminal of a first sliding rheostat connected to the connecting portion;
changing a capacitance of a varicap connected to the first sliding rheostat, when the sliding terminal of the first sliding rheostat is slid;
changing a voltage of a frequency-to-voltage converter connected to the varicap according to the capacitance of the varicap,
comparing the voltage of the frequency-to-voltage converter with a predetermined voltage by a comparing module connected to the frequency-to-voltage converter; and
lighting an indicator module when the voltage of the frequency-to-voltage converter is greater than the predetermined voltage.

12. The water-level detecting method of claim 11, wherein the comparing module comprises an operational amplifier, a positive terminal of the operational amplifier is connected to the frequency-to-voltage converter and receiving the voltage of the frequency-to-voltage converter by the positive terminal of the operational amplifier, and a negative terminal of the operational amplifier and receiving the predetermined voltage by the negative terminal of the operational amplifier.

13. The water-level detecting method of claim 11, wherein the detecting module comprises a first capacitor, a first node, a first resistor, and a first sliding rheostat; a pin CAP1 of the frequency-to-voltage converter is grounded via the first capacitor, the first node and the varicap, the first node is connected to the sliding terminal of the first sliding rheostat via the first resistor, and the connecting portion is connected to the sliding terminal of the first sliding rheostat.

14. The water-level detecting method of claim 13, wherein the detecting module further comprises a second sliding rheostat, a third sliding rheostat, a second resistor, a third resistor, a fourth resistor, and a second node; a pin E and a pin IN− of the frequency-to-voltage converter are connected to the second node, a first connecting terminal of the second sliding rheostat is connected to the second node, a sliding terminal of the second sliding rheostat is connected to the positive terminal of the operational amplifier via the second resistor, and a second connecting terminal of the second sliding rheostat is grounded; a sliding terminal of the third sliding rheostat is connected to the negative terminal of the operational amplifier via the third resistor; and the operational amplifier is connected to the indicator module via the fourth resistor.

15. The water-level detecting method of claim 13, wherein the detecting module further comprises a second capacitor and a fifth resistor; a pin CPO of the frequency-to-voltage converter is grounded via a fifth resistor, and a pin IN+ of the frequency-to-voltage converter is connected to the pin CPO and further is grounded via the second capacitor.

16. The water-level detecting method of claim 13, wherein the detecting module further comprises a displaying meter, a fourth sliding rheostat, and a six resistor; the displaying meter is configured for displaying the water level in the water tank; a first connecting terminal and a sliding terminal of the fourth sliding rheostat are connected to the second node, a second connecting terminal of the fourth sliding rheostat is connected to the six resistor; and the six resistor is grounded by the displaying meter.

17. The water-level detecting method of claim 13, wherein the water-level detecting method further comprises a seventh resistor and a power supply, the pin E of the frequency-to-voltage converter is grounded via the seventh resistor, and a pin VCC and a pin C of the frequency-to-voltage converter are connected to the power supply.

18. The water-level detecting method of claim 17, wherein a first connecting terminal of the first sliding rheostat is connected to the power supply, a second connecting terminal of the first sliding rheostat is grounded; a first connecting terminal of the third sliding rheostat is connected to the power supply, a second connecting terminal of the third sliding rheostat is grounded.

19. The water-level detecting method of claim 17, further comprising a signal generating module connected to the frequency-to-voltage converter, wherein transmitting a frequency signal to the frequency-to-voltage converter by the signal generating module.

20. The water-level detecting method of claim 19, wherein the signal generating module comprises a base-time circuit, a third node, a third capacitor, a fourth capacitor, a fifth capacitor, a ninth resistor, a tenth resistor, and a eleventh resistor; the time-base circuit comprises an output pin, a ground pin, a low trigger pin, a high trigger pin, a power supply pin, and a discharge pin; the output pin is connected to the third capacitor, the third capacitor is connected to a pin TACH+ of the frequency-to-voltage converter via the ninth resistor; the ground pin is connected to the power supply via the fourth capacitor; the low trigger pin is grounded via the fifth capacitor; the third node is connected to the lower trigger pin and the high trigger pin; the power supply pin is connected to the power supply; the discharge pin is grounded via a ninth resistor; and the eleventh resistor is connected to the discharge pin and the third node.
